(19) United States
(12) Patent Application Publication
(10) Pub. No.: US 2024/0399381 A1
(43) Pub. Date: Dec. 5, 2024

(54) CASSETTE CONFIGURED TO CONTAIN A MICROFLUIDIC CHIP

(71) Applicant: GESVAL S.A., Angleur (BE)

(72) Inventor: Stéphanie VAN LOO, Beaufays (BE)

(73) Assignee: GESVAL S.A., Angleur (BE)

(21) Appl. No.: 18/694,237

(22) PCT Filed: Sep. 21, 2022
(86) PCT No.: PCT/EP2022/076279

§ 371 Date: Mar. 21, 2024

(30) Foreign Application Priority Data
Sep. 21, 2021 (BE) BE2021/5745

(51) Int. Cl. B01L 9/00; B01L 3/00

(52) U.S. Cl. CPC B01L 9/527; B01L 3/502715; B01L 2200/027; B01L 2300/0809

(57) ABSTRACT

A cassette is configured to contain a microfluidic chip. The cassette includes a base made of rigid material and provided with a first wall. The cassette further includes a cover made of rigid material and provided with a second wall. The cassette has an analysis position and an introduction position. Each of the first wall and the second wall has an optically transparent viewing zone. The cassette further includes a series of connecting orifices, each orifice of the series of connecting orifices being designed to be passed through by a connecting tube allowing the passage of a fluid. The second wall also comprising at least one sample introduction orifice.

The invention relates to a cassette intended to contain a microfluidic chip formed by a base made of rigid material and provided with a first wall and a cover made of rigid material and provided with a second wall, said cassette having an analysis position and an introduction position, said analysis position being a closed position wherein said first wall is opposite said second wall and is spaced apart from the second wall by a predetermined distance, optionally by a spacing means, and forms a receiving cavity for a microfluidic chip, said first wall and said second wall each comprising an optically transparent viewing area, the viewing area of said first wall being positioned so that it is at least partially aligned transversally with the viewing area of said second wall when the cassette is in the analysis position, said cassette comprising a series of connection ports, each port of said series of connection ports being arranged to be passed through by a connection tube enabling a fluid to pass through, said second wall further comprising at least one sample introduction port, said sample introduction port having a diameter greater than 1 mm and being intended to receive a tapered tank.

Microfluidic experimentation consists of carrying out experiments involving the flow of liquids in channels of micrometric size. The flow of fluids in these channels means that the frictional forces associated with viscosity far outweigh the inertial forces associated with the flow. This results in a laminar flow in which the molecules making up the fluid move forwards while maintaining their relative positions to one another.

This laminar flow has enabled the development of numerous applications, including droplet microfluidics. Unlike continuous flow systems, droplet microfluidic systems are based on the fragmentation of a liquid phase into a second immiscible phase (e.g. water in oil).

Droplet microfluidic systems involve generating and handling discrete droplets within microfluidic channels. This method produces well-defined droplets, having a diameter ranging from a micrometre to several hundred micrometres, at a rate of up to twenty thousand droplets per second. Thanks to their high surface-area-to-volume ratio, diffusion phenomena and mass and heat transfer are faster, enabling shorter reaction times. Unlike continuous flow systems, droplet microfluidic systems enable each droplet to be independently controlled, generating microreactors that can be individually transported, mixed and analysed.

The possibility of handling very small sample volumes is a major advantage of microfluidic analysis. This enables analyses to be carried out using a small quantity of material and reduces reagent consumption.

A microfluidic chip is a set of microchannels engraved or moulded in a material (glass, silicon, polymer such as polydimethylsiloxane, PDMS). The microchannels making up the microfluidic chip are connected to each other so as to carry out a desired function such as sorting, separating or mixing. This microchannel network enclosed in the chip is connected to the outside environment by inlets and outlets pierced through the chip. It is through these ports that gases and liquids are injected and discharged from the chip. To be able to monitor, understand and analyse phenomena, microfluidic chips are generally placed on a plate of a microfluidic experimentation device.

More generally, a microfluidic experimentation device includes, but is not limited to, a microscope module (inverted or not), a fluorescence detection module with light excitation comprising one or more lasers and photomultiplier sensors, a pneumatic module typically comprising pumps, pressure regulators, solenoid valves, a fluidic module comprising connection tubes, tanks, an electronic module equipped with a component power supply, signal acquisition means, mechanical parts and support.

Depending on the experiments carried out, the operator will need all the modules or only some of them and more or fewer tanks.

There are microfluidic experimentation devices where the modules are integrated, for example in a box, and typically, the modules integrated in the box are pneumatic modules. The box comprising the pneumatic modules is often located under the plate of the microfluidic experimentation device. In some microfluidic experimentation devices, the pneumatic module is a separate module to be placed on the table near to the microfluidic experimentation device. Arrangements are generally varied for the fluidic module, with some tanks being located in different places depending on what they need to contain.

Therefore, before carrying out an experiment or analysis using a microfluidic chip, the operator must connect the various gas and liquid inlets and outlets to the circuit(s) of the microfluidic chip(s) using connection tubes. Connection tubes are flexible pipes, generally made of PVC (Polyvinyl Chloride), FEP (Fluorinated Ethylene Propylene) or silicone, such as tubing or capillaries.

When some modules are integrated in a box under the plate, the connection tubes will have to be passed through the hole in the plate intended to let light pass through, while other connection tubes will have to connect bottles, flasks or tubes on the table to the microfluidic chip located under the microfluidic experimentation device, on the plate.

As can be easily understood, a microfluidic experiment generally results in a tangle of connection tubes and an unpleasantly crowded workspace. Moreover, the assembly of the connection tubes to the chip is not very robust and the slightest movement may disengage the connection tube from its point of entry into the tube. Moreover, sometimes part of the experiment has to be carried out under a sterile fume hood and the chip then has to be brought from the sterile fume hood to the microfluidic experimentation device, as well as a series of tubes acting as tanks. In other cases, part of the fluid circuit, the chip, the connections, the connection tubes etc. must be sterilised beforehand, which makes it difficult to create circuits provided with their connection tubes for connection to the tanks.

Protections for microfluidic chips designed for predefined applications are also known, such as those described in document US2012/0040470, which involves protecting the chip with a sealing film in which prearranged holes are created. Unfortunately, while this concept is feasible for predefined and systematic applications and nevertheless makes it easier to connect the microfluidic chip to the tanks via connection tubes, the protection of the chip and its connections is still very basic.

Other examples of cassettes for microfluidic chips can be found in documents US2020240898, US2017014824, US2013164192 and US2021162421. Unfortunately, although these concepts improve the protection of the chip and its connections within a fluidic experimentation device, they do not solve the problem of making it easier to inject a sample into a microfluidic chip.

The purpose of the invention is to overcome these disadvantages by providing a cassette intended to contain a microfluidic chip, enabling the microfluidic chip to be housed and the microfluidic experiment to be prepared, applicable for specific and systematic applications or for diversified applications. In other words, the cassette according to the present invention is a cassette that enables the predetermined experiment or analysis to be prepared by very simply and robustly adapting to numerous applications. In particular, the cassette solves the problem of there being a large dead volume when injecting a sample into a microfluidic chip.

To solve this problem, the invention provides a cassette as mentioned at the beginning, characterised in that the tip of said tank (19) projects on both sides of said sample introduction port (11), and that said cassette comprises a tank holder comprising (i) an outer side wall defining a cavity, (ii) an upper end provided with an upper port and (iii) a lower end provided with a lower port, said tank holder being in fluid communication with said sample introduction port when the cassette is in the analysis position and therefore arranged to be connected to said sample introduction port, said lower port having a diameter smaller than the diameter of said upper port and being sized so that it can abuttingly receive a side portion of a tapered-end tank and house it so that a most pointed end of said tapered-end tank projects from the sample introduction port and ends in the receiving cavity for the microfluidic chip, optionally in a receiving area (area of the receiving cavity limited by baffles) while a residual portion of the tapered-end tank is housed in the tank holder.

As can be seen, said sample introduction port has a diameter greater than 1 mm and is intended to receive a tapered-end tank, for example the tip of a pipette (disposable Pasteur pipette) or the tip of a (micro) pipette tip so that the tip projects on both sides of said sample introduction port, or a bespoke tank having substantially the same geometry as a (micro) pipette tip.

The volume of sample that can be housed in the tapered end of the tapered-end tank can have a volume from 1 μl to 30,000 μl, preferably from 3 μl to 10,000 μl, preferably from 10 μl to 3,000 μl, preferably 50 μl to 1,000 μl. If the tapered-end tank is a tip, one of the following tips will be used: a 0.1-20 μl tip, a 0.5 μl-20 μl tip, a 2 μl-200 μl tip, a 5 μl-300 μl tip, a 50 μl-1,000 μl tip, a 50 μl-1,250 μl tip, a 0.5 ml-5 ml tip, a 1 ml-10 ml tip.

Typically, the presence of a sample introduction port enables the tip of a tapered-end tank to be passed from the outside of the cassette, through said sample introduction port and enables the portion that projects to be housed between the first wall and the second wall, directly in the inlet for the sample to be analysed of the chip. The presence of a tank in the tank holder, directly in contact with the sample introduction port, reduces the dead volume of the sample and prevents biological (cells, etc.) or particulate (functional microbeads, etc.) samples from being lost in the connection tubes/connections normally used to connect the tank containing the sample to be analysed and the sample introduction port. This is particularly useful for “single-cell” sample analysis experiments containing small quantities of rare and/or valuable cells, typically for screening rare cells (circulating tumour cells, immune cells, etc.), but without weakening the joint between the tapered-end tank and the sample introduction port.

The presence of a tank holder on the cassette or integral with the cassette enables the tapered-end tank to be held in place in the sample introduction port. The tank holder is in fluid communication, or aligned on the cassette, with the sample introduction port, so that the tip of the tapered sample tank, which is located in the tank holder, is inserted into the centre of the sample introduction port. The tip of the tapered-end tank is held in place by the tank holder, which makes the system robust. The tank holder is arranged so that the technician can insert the tapered-end tank into the tank holder by pushing it firmly, since the tip of the tapered-end tank is held rigidly in place by the tank holder and there is no risk of it entering too deeply into the chip thanks to the fact that it is sized to abuttingly receive a side portion of a tapered-end tank (for example, one or more tips or pipette tips) and house it so that a most pointed end of said tank projects from the sample introduction port and ends in the receiving cavity (or optionally in a receiving area delimited by baffles in the receiving cavity) while a residual portion of the tapered-end tank is housed in the tank holder.

As can be seen, the cassette according to the present invention has a base and a cover which have an analysis position, i.e. a closed position and an introduction position which is an open position in which the base and the cover are spread apart in order to introduce a microfluidic chip. When the cassette is in the closed position, the base and the cover respectively have a first wall and a second wall which are spaced apart from each other, optionally by a spacing means, by a predetermined distance.

A predetermined distance means a distance corresponding substantially to the thickness of a microfluidic chip, of between 1 mm and 10 mm, typically between 3 mm and 4 mm. The spacing means has a substantially similar height to the thickness of the microfluidic chip and thus enables the microfluidic chip to be confined between the first wall and the second wall. This spacing by a predetermined distance prevents the microfluidic chip from being crushed if it is made of a soft material or broken if it is made of a rigid material.

In an advantageous embodiment, the spacing means is present on the base and may be the peripheral side wall or a series of side wall pieces. In this case, the spacing means has a height corresponding to the predetermined distance.

In one embodiment of the cassette according to the present invention, the peripheral side wall or the series of side wall pieces advantageously fit(s) into the cover and come(s) into contact with the peripheral edge of the cover. In this case, the spacing means also forms the closing means of the cassette according to the invention.

In one variant, the base includes a series of baffles in the receiving cavity, forming a receiving area for the microfluidic chip and the spacing means is formed by the baffles 6, whether transverse or lateral, if the height of at least two of them is greater than or equal to the height of the peripheral side wall 4, the height of said at least two baffles corresponding to the predetermined distance.

In yet another variant, the spacing means is formed by spacing baffles or pillars on the first wall and extending from the first wall, optionally in addition to the baffles forming the receiving area.

In yet another variant, the spacing means is present on the cover and is formed by the peripheral edge 23 of the cover.

In yet another variant, the spacing means is present on the cover and comprises pillars or baffles extending from an inner surface of the second wall of the cover of the cassette.

In yet another variant, the cassette does not have spacing means. The microfluidic chip itself acts as a spacing means, said predetermined distance corresponding to the height of the chip.

In the cassette according to the present invention, said first wall and said second wall each comprise an optically transparent viewing area which are each positioned so that they are at least partially aligned transversally with each other in order to enable light to pass through and to enable analysis under the microscope. The viewing area of the cassette according to the present invention may be made of glass, an optically transparent polymer or even a filtering polymer, or simply an area without material, i.e. provided with a hole. If the whole of the cassette is made of an optically transparent polymer or material, then the viewing area extends over the entire cassette. Preferably, the two viewing areas are arranged at a place corresponding to a key area of the microfluidic circuit in which the phenomenon to be observed occurs. The cassette according to the present invention also comprises a series of connection ports, each port of said series of connection ports being arranged to be passed through by a connection tube enabling a fluid to pass through. The connection ports may be located on the upper or lower wall or on a side wall when present. The connection tube may thus be connected, for example, to the fluid tank and to the microfluidic circuit, or to a pneumatic source and to a tank, or even to a pneumatic source and to the microfluidic circuit. It is therefore possible to prepare the chip in advance, install it in the cassette and make the connections with the connection tubes beforehand, in a place separate from the place where the microfluidic experiment will occur, for example, under a fume hood and then move the assembly comprising the chip, its cassette and its fluidic connections to the microfluidic experimentation machine without fear of detaching the various connections or damaging the microfluidic chip and making it easier to position in the microfluidic experimentation machine, under the light beam, the connections to the microfluidic chip being made more robust and moveable. Moreover, the second wall further comprises at least one sample introduction port which enables the sample to be introduced into the inlet for the sample to be analysed of the microfluidic chip. This sample introduction port may, for example, directly house a suitable tank or a sample supply connection tube. It is therefore understood that the cassette according to the present invention enables the work to be prepared in advance of the microfluidic experiment, but also makes assembling the connection tubes to the chip easy and robust.

In an advantageous embodiment of the present invention, said series of connection ports comprises a first set of connection ports positioned on said first wall and a second set of connection ports positioned on the second wall, said first set of connection ports and said second set of connection ports having an identical or different number of connection ports, said number of connection ports being selected from 1, 2, 3, 4, 5, 6, 7, 8, 9, 10, at least one port of said first set of connection ports and at least one connection port of said second set of connection ports being aligned transversally when the cassette is in the analysis position.

Typically, the presence of at least one port of said first set of connection ports and at least one connection port of said second set of connection ports which are aligned transversally when the cassette is in the analysis position enables a connection tube connected to a module under the chip, such as a module housed in a microfluidic experimentation device box under the plate of the microfluidic experimentation device, to be passed through it, through the connection port in the first wall and therefore in the base, to then be passed through the connection port in the second wall and therefore in the cover, in order to pass it from under the plate of the microfluidic experimentation device to above the plate of the microfluidic experimentation device when the cassette is housed under the light beam without weakening the connections, but rather by providing a guide adapted to them. The end of the connection tube is then connected to another port in the cassette, to an inlet of the chip, to a reagent tank for the microfluidic experiment, for example, to pressurise it because the other side of the connection tube is connected to the pneumatic module. The presence of these aligned ports thus makes assembly and connection easier, since it brings the end of the connection tubes connected to other modules below the cassette and plate back into the field of vision of the operator.

In another preferred embodiment of the present invention, said series of connection ports further comprises a set of fluid connection ports, each fluid connection port being arranged to enable an inlet or outlet connection tube for a fluid intended to circulate in a microfluidic circuit of the microfluidic chip to pass through.

Typically, the presence of at least one fluid connection port enables a connection tube, for example a connection tube, to be passed from the outside of the cassette to the microfluidic chip. To carry out a microfluidic experiment, a fluid is to be moved within the microfluidic chip. The presence of these connection tubes enables fluids to be introduced into and removed from the microfluidic chip. If only one fluid connection port is present on the cassette according to the present invention, the fluid inlet or outlet may be in a port intended for another purpose, for example the viewing window. The connection tubes can transport liquids needed for the experiment, such as the continuous phase surrounding the microfluidic droplets, the reagents needed to form the droplets, the reagents needed for the experiment, and also the sorted and unsorted droplets leaving the microfluidic chip. These connection tubes can also transport gases to operate valves within the microfluidic chip. The presence of these fluid connection ports makes it easier to set up fluid experiments and strengthens the connection between the connection tubes and the microfluidic chip. The connections between the connection tubes and the microfluidic chip are under less stress thanks to the connection tubes passing through the fluid connection ports, which also keep them at a fixed distance from each other.

In yet another advantageous embodiment according to the present invention, said base and/or the cover has/have one or more baffles delimiting a receiving area arranged to receive and confine the microfluidic chip in a predetermined analysis position when the cassette is in the analysis position.

In most microfluidic chips, the channels for fluid flow are not present on the entire surface of the chip. Moreover, not all of these channels are of interest for microscope observation. It is therefore important, during a microfluidic experiment, to position the chip accurately relative to the optical module in order to be able to analyse the experiment in progress. The baffles present in the cassette enable the chip to be placed in a position suitable for optical analysis. The baffles help to hold the chip in place during the experiment and enable chip positioning errors to be reduced and the chip to be aligned with the connection ports and the sample tank.

Preferably, in the cassette according to the present invention, the fluid connection ports of said set of fluid connection ports are located in an area of the first or second wall so as to end in the receiving area.

More particularly, according to the present invention, said cavity of the tank holder is a cavity having a diameter which tapers from the upper end towards the lower end, the inner side wall of said cavity being arranged to be in contact with an outer surface of a side wall of said tapered-end tank, which enables it to be tightly received and makes it easier to introduce the tip of the tapered-end tank into the sample inlet present on the chip.

A diameter which tapers from the upper end towards the lower end means a diameter that decreases in a substantially constant manner, such as a tapered cavity, or a diameter that decreases incrementally, such as a cavity having one or more tapering shoulders in the side wall, or a combination thereof.

In a preferred embodiment of the cassette according to the present invention, said sample introduction port is provided with attachment means arranged to attach a tank or a tank holder, which makes the tank or tank holder integral and makes the assembly of the microfluidic circuit more robust.

In another preferred embodiment of the cassette according to the present invention, the lower end of the tank holder is arranged to be screwed into a thread formed in the sample introduction port, or fitted, glued or welded.

Advantageously, according to the present invention, said spacing means is selected from a plurality of spacer blocks, a plurality of stops, a side wall which may comprise connection ports, a set of side walls and combinations thereof, said spacing means being present on the cover and/or on the base of said cassette.

More particularly, according to the present invention, said cover is removably connected to said base by connecting means selected from at least one hinge, a plurality of stud inserts, a plurality of clamps, a plurality of tubes and tenons, a plurality of tongues and mortises to enable them to be joined and combinations thereof.

The invention also relates to an assembly comprising a cassette intended to contain a microfluidic chip according to any one of the preceding claims, wherein the cassette and the tank holder are assembled or to be assembled.

Advantageously, according to the present invention, said assembly comprises a microfluidic chip, housed in the receiving cavity, preferably in the receiving area.

More particularly, according to the present invention, the base and the cover of said assembly are sealed.

Other embodiments of the cassette according to the invention are mentioned in the appended claims.

Other features, details and advantages of the invention will emerge from the description given below, which is non-limiting and refers to the drawings.

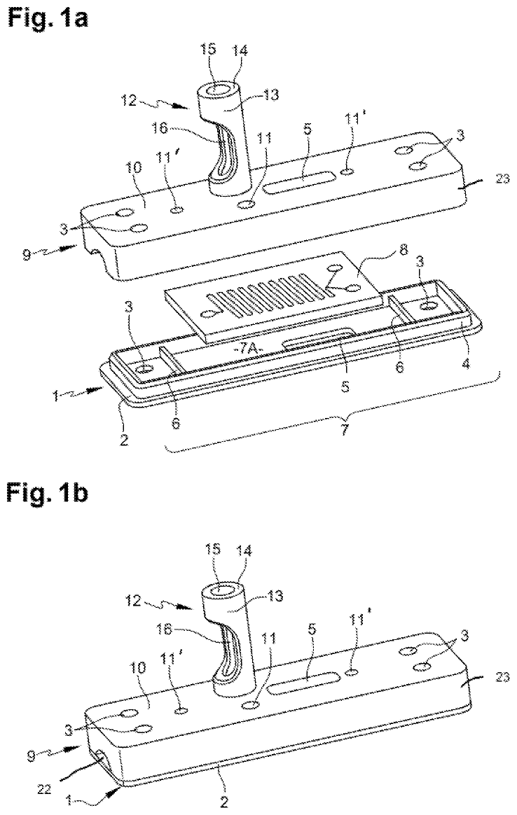

In the drawings, FIG. 1A is an exploded view of the cassette intended to contain a microfluidic chip according to the invention, in the introduction position.

FIG. 1b shows the cassette intended to contain a microfluidic chip according to the invention, in the analysis position.

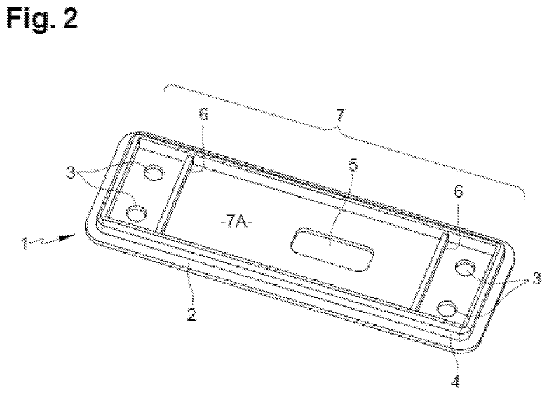

FIG. 2 shows a perspective top view of the base of the cassette intended to contain a microfluidic chip according to the invention.

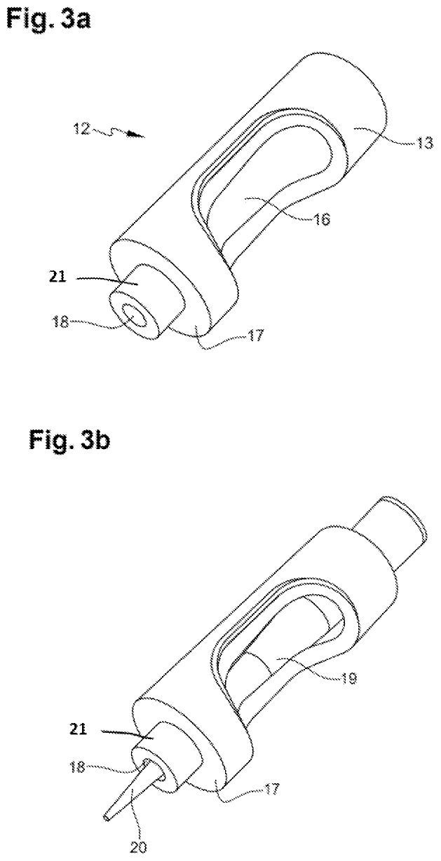

FIG. 3a shows the tank holder of the cassette intended to contain a microfluidic chip according to the invention.

FIG. 3b shows the tank holder of the cassette intended to contain a microfluidic chip according to the invention, containing a tapered sample tank.

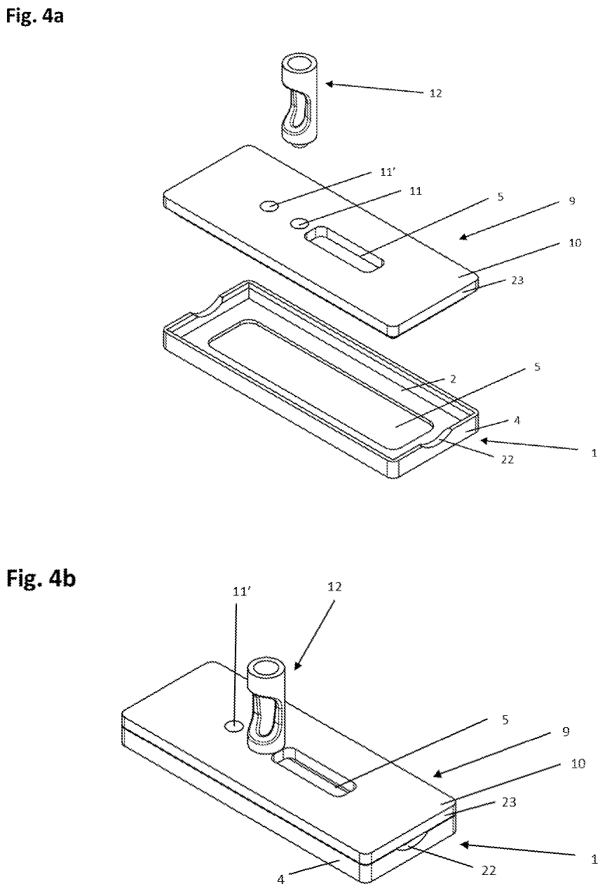

FIG. 4a is an exploded view of the cassette intended to contain a microfluidic chip according to the invention, in the introduction position.

FIG. 4b shows the cassette intended to contain a microfluidic chip according to the invention, in the analysis position.

In the figures, the same or like items bear the same references.

As can be seen in FIG. 1A and 1B, the cassette according to the present invention comprises a base 1 with a first wall 2. The first wall 2 comprises connection ports 3 and a peripheral side wall 4 which acts, for example, as a spacing means (also see FIG. 2). The peripheral side wall 4 may be a continuous wall or a series of side wall pieces. The first wall 2 also comprises a viewing area 5 and baffles 6. The baffles 6 delimit a receiving area 7A for a microfluidic chip 8 in the inner receiving cavity 7, itself delimited by the peripheral side wall 4. In this embodiment, the spacing means is a peripheral side wall 4 present on and extending from the first wall 2 of the cassette.

Sometimes, when the chip is present, it will be thicker than the predetermined distance and will act as a spacing means when the cassette is in the closed position.

For the purposes of the present invention, the spacing means present on the base 1 may be the peripheral side wall 4 or a series of side wall pieces 4. The peripheral side wall 4 or the series of side wall pieces 4 advantageously fit(s) into the cover 9 and come(s) into contact with the peripheral edge 23 of the cover. In this case, the spacing means also forms the closing means of the cassette according to the invention.

In one variant, the base 1 comprises a series of baffles 6 in the receiving cavity 7 forming a receiving area 7A for the microfluidic chip. The spacing means may also be formed by baffles 6, whether transverse or lateral, if the height of at least two of them is greater than or equal to the height of the peripheral side wall 4.

In yet another variant, the spacing means is formed by spacing baffles or pillars on the first wall 2 and extending from the first wall 2, optionally in addition to the baffles 6 forming the receiving area.

In yet another variant, the spacing means is present on the cover and is formed by the peripheral edge 23 of the cover.

In yet another variant, the spacing means is present on the cover and comprises pillars or baffles extending from the inner surface of the second wall 10 of the cover 9 of the cassette.

In FIG. 1A, the cassette is in the introduction position and a microfluidic chip 8 is shown above the base 1, ready to be inserted into the receiving cavity 7. The receiving cavity comprises baffles 6 forming a receiving area 7A in the receiving cavity. The cover 9 of the cassette is shown above the microfluidic chip 8. The cover 9 has a second wall 10 comprising a viewing area 5, connection ports 3, sample introduction ports 11, fluid connection ports 11′, a peripheral edge 23 and a tank holder 12, in fluid communication with one of the sample introduction ports 11. In one variant, the cassette may comprise a tank holder 12 for each sample introduction port 11 or several sample introduction ports 11. The tank holder 12 comprises an outer side wall 13. The upper end 14 and the upper port 15 of the tank holder 12 can be seen in the figures. The outer side wall 13 of the tank holder defines a cavity 16 capable of receiving a sample tank.

In FIG. 1B, the cassette is closed and in the analysis position.

The connection ports 3 present on the first wall 2 and on the second wall 10 enable connection tubes to be passed from under the cassette to the top of the cassette and vice versa in a part adjoining the receiving area 7A in the receiving cavity 7 for the microfluidic chip, so as to not hinder the experiment or the introduction of the chip into the cassette. In some embodiments, the first wall 2 and/or the second wall 10 have fluid connection ports 11′ for connecting the top or bottom of the microfluidic chip via the fluid connection ports 11′ of the cassette to fluidic or pneumatic modules of the microfluidic experimentation device. These modules can be independently above or below the cassette according to the invention. Moreover, the connection ports 3 enable the connection tubes to be kept outside the optical field of the microfluidic experiment, but also to be held in place and spaced apart from each other, without imposing constraints on the inlet or outlet of the microfluidic chip. These fluid connection ports 11′, in addition to making it easier to assemble the microfluidic circuit, act as a guide for the connection tubes.

When using a cassette intended to contain a microfluidic chip according to the invention, a microfluidic chip 8 is placed in the receiving area 7A for a microfluidic chip located on the second wall 2 of the base 1 and delimited from the receiving cavity 7 by baffles 6. The cover 9 is then connected to said base 1 by the peripheral side wall or optionally by connecting means not shown in the drawings. In the embodiment shown, the cover 9 and the base 1 may be separated from each other and a peripheral side wall 4 enables the first wall 2 to be spaced apart from the second wall 10. The separation of the two parts may be facilitated by the presence of an opening facilitator 22. It is also envisaged for the purposes of the present invention that the cover 9 and the base 1 are articulated with one or more hinges and that the spacing means 4 are, for example, stops or spacer blocks which do not hinder the pivoting movement of the cover 9 relative to the base I due to the hinges. It may also be provided that the cover is glued to the base or that the two parts are fitted together by force fitting.

The viewing areas 5 of the first wall 2 and the second wall 10 are positioned so that they are at least partially aligned transversally with each other and with the area to be optically analysed on the microfluidic chip 8 located in the receiving area 7A delimited from the receiving cavity 7 by baffles 6. The fluid connection ports 11′ on the first wall 2 and the second wall 10 are arranged to face the ports pierced in the microfluidic chip 8. Depending on the positioning of the pneumatic and fluidic modules and the positioning of the ports pierced in the microfluidic chip 8 needed for the microfluidic experiment, one or more connection tubes pass through the connection ports 3 to provide the fluid(s) to be used on the correct side of the cassette. Depending on the microfluidic experiment, one or more tanks 19 and/or one or more tank holders 12 are connected to one or more sample introduction ports 11. The tank holder(s) is (are) inserted by fitting it (them) into the sample introduction port 11 or screwed into an internal thread (not shown) formed in a sample introduction port 11. The tank holder may be glued or welded to the cover or even be a single piece with the cover (obtained by moulding, 3D printing, etc.). A tapered-end tank 19 is inserted into a tank holder 12 and the most pointed end of the tank 20 projects from the sample introduction port 11 in order to be pushed into a port pierced in the microfluidic chip 8. The tapered-end tanks 19 are then connected to the pneumatic module of the microfluidic experimentation device by means of connections and connection tubes.

FIGS. 3A and 3B show the tank holder 12 to be positioned on a cassette intended to contain a microfluidic chip according to the invention. This comprises an outer side wall 13 defining a cavity 16. The lower end 17, the outer wall 21 of the lower end 17 and the lower port 18 are shown. FIG. 3B shows the tank holder in which a micropipette or pipette tip (tapered-end tank) 19 is housed. The tank holder 12 is arranged so that the most pointed end of the sample tank 20 projects from the lower port 18 of the tank holder 12.

The cavity 16 of the tank holder 12 has a diameter which tapers from the upper end 14 towards the lower end 17, the side wall of said cavity 16 is arranged to hold the tank 19 so that the most pointed end of the tank 20 projects from the lower port 18 by an adequate length to pass through a sample introduction port 11 and into a port in the microfluidic chip. The port in the chip must be of a suitable size, e.g. slightly smaller, if the material of the microfluidic chip is flexible PDMS, than that of the most pointed end 20 of the tank 19, so that the seal between the tank and the microfluidic chip is ensured when the tank 19 is pushed into the tank holder 12 and ends in the chip. This is advantageously made easier because the inner side wall of the cavity 16 is sized so that the cavity 16 can abuttingly receive a side portion of a tapered-end tank 19 and house it so that a most pointed end 20 of said tank 19 projects from the sample introduction port and ends in the receiving area 7A for the microfluidic chip 8, while a residual portion of the tank 19 is housed in the tank holder 12.

FIGS. 4a and 4b show an embodiment according to the present invention. Compared to the embodiment in FIGS. 1a and 1b, the cassette comprises a base 1 comprising a viewing window 5 on the first wall 2. As with the base 1 in FIG. 1a, a peripheral side wall 4 extends from the first wall 2. The cover also comprises a second wall 10 provided with an optically transparent viewing window 5 and a sample introduction port 11 in which a tank holder according to FIG. 3 is present. The viewing area 5 of said first wall 2 is positioned so that it is at least partially aligned transversally with the viewing area 5 of said second wall 10 when the cassette is in the analysis position.

In the embodiment shown, said cassette comprises a fluid connection port 11′, arranged to be passed through by a connection tube enabling a fluid to pass through. In use, the fluid passing through the connection tube connecting the tank to the microfluidic chip 8 (as shown in FIG. 1a) ends in a channel in the microfluidic chip 8. The fluid is used, for example, to move a sample or is a reagent. The sample introduced, for example, via a micropipette tip, which is placed into the sample holder connected to the sample introduction port 11, circulates in the microfluidic chip 8 and emerges in the embodiment shown of the cassette at the viewing window 5. When a tip is introduced into the tank holder, the tip projects to end in the receiving cavity, and when the chip is present, into the channel of the chip. In this embodiment, the microfluidic chip 8 can act as a spacing means 4 when present. Alternatively, when it is not already present, this role is played by the peripheral side wall 4 of the base 1 of the cassette, which fits into the peripheral edge of the cover 9, similarly forming closing means for the cassette.

It is to be understood that the present invention is in no way limited to the embodiments described above and that modifications may be made without departing from the scope of the appended claims.

For example, the fluid connection port present on the cover or the base could be merged with the viewing window on the cover or base respectively, thus providing access to the microfluidic circuit of the microfluidic chip.

1. A cassette configured to contain a microfluidic chip, the cassette comprising a base made of rigid material and provided with a first wall and a cover made of rigid material and provided with a second wall, said cassette having an analysis position and an introduction position, said analysis position being a closed position wherein said first wall is opposite said second wall and is spaced apart from the second wall by a predetermined distance and forms a receiving cavity configured to receive a microfluidic chip, said first wall and said second wall each comprising an optically transparent viewing area, the viewing area of said first wall being positioned to be at least partially aligned transversally with the viewing area of said second wall when the cassette is in the analysis position, said cassette comprising a series of connection ports, each port of said series of connection ports being arranged to be passed through by a connection tube enabling a fluid to pass through, said second wall further comprising at least one sample introduction port, said sample introduction port having a diameter greater than 1 mm and being configured to receive a tapered tank, wherein a tip of said tank projects on both sides of said sample introduction port, and said cassette comprises a tank holder comprising (i) an outer side wall defining a cavity, (ii) an upper end provided with an upper port and (iii) a lower end provided with a lower port, said tank holder being in fluid communication with said sample introduction port when the cassette is in the analysis position and therefore arranged to be connected to said sample introduction port, said lower port having a diameter smaller than a diameter of said upper port and being sized to abuttingly receive a side portion of a the tapered tank and house the tapered tank so that a most pointed end of said tapered tank projects from the sample introduction port and ends in the receiving cavity while a residual portion of the tapered tank is housed in the tank holder.

2. The cassette according to claim 1, wherein said series of connection ports comprises a first set of connection ports positioned on said first wall and a second set of connection ports positioned on the second wall, said first set of connection ports and said second set of connection ports having an identical number of connection ports, said number of connection ports being selected from 1, 2, 3, 4, 5, 6, 7, 8, 9, 10, at least one port of said first set of connection ports and at least one connection port of said second set of connection ports being aligned transversally when the cassette is in the analysis position.

3. The cassette according to claim 1, wherein said series of connection ports further comprises a set of fluid connection ports, each fluid connection port being arranged to enable an inlet or outlet connection tube for a fluid configured to circulate in a microfluidic circuit of the microfluidic chip to pass through.

4. The cassette according to claim 1, wherein said base and/or the cover has/have one or more baffles delimiting a receiving area arranged to receive and confine the microfluidic chip in a predetermined analysis position when the cassette is in the analysis position.

5. The cassette according to claim 3, wherein said base and/or the cover has/have one or more baffles delimiting a receiving area arranged to receive and confine the microfluidic chip in a predetermined analysis position when the cassette is in the analysis position, and the fluid connection ports of said set of fluid connection ports are located in an area of the first wall or the second wall so as to end in the receiving area.

6. The cassette according to claim 1, wherein said cavity is a cavity having a diameter which tapers from the upper end towards the lower end, the inner side wall of said cavity being arranged to be in contact with an outer surface of a side wall of said tapered tank.

7. The cassette according to claim 1, wherein said sample introduction port is provided with attachment means arranged to attach the tank or the tank holder.

8. The cassette according to claim 1, wherein the lower end of the tank holder is arranged to be screwed into a thread formed in the sample introduction port, or fitted, glued or welded.

9. The cassette according to claim 1, wherein said spacing means is selected from a plurality of spacer blocks, a plurality of stops, a side wall, a set of side walls and combinations thereof, said spacing means being present on the cover and/or on the base of said cassette.

10. The cassette according to claim 1, wherein said cover is removably connected to said base by connecting means selected from at least one hinge, a plurality of stud inserts, a plurality of clamps, a plurality of tubes and tenons, a plurality of tongues and mortises to enable the cover and the base to be joined.

11. An assembly comprising the cassette according to claim 1, wherein the cassette and the tank holder are assembled or to be assembled.

12. The assembly according to claim 11, further comprising a microfluidic chip housed in the receiving cavity.

13. The assembly according to claim 12, wherein the base and the cover are sealed.

14. The cassette according to claim 1, wherein in the analysis position, said first wall is spaced apart from the second wall by a spacing means.

15. The cassette according to claim 1, wherein the most pointed end of said tapered tank ends in a receiving area.
